(19) United States
(12) Patent Application Publication
(10) Pub. No.: US 2012/0235776 A1
(43) Pub. Date: Sep. 20, 2012

(54) COMPOUND ELECTRONIC DEVICE AND METHOD FOR DISPLAYING IMAGE DATA

(75) Inventor: Kim Yeung Sip, Taipei Hsien (TW)

(73) Assignee: ACER INCORPORATED, Taipei Hsien (TW)

(21) Appl. No.: 13/242,636

(22) Filed: Sep. 23, 2011

(30) Foreign Application Priority Data
Mar. 15, 2011 (TW) 100108678

(51) Int. Cl. H01F 7/06

(52) U.S. Cl. 335/219

(57) ABSTRACT

A compound electrical device includes a first mobile device and a second mobile device. The first mobile device includes: a first electromagnet, generating a first magnetic pole; and a first monitor. The second mobile device includes: a sensor, detecting the first magnetic pole and generating an enable signal; a second electromagnet, generating a second magnetic pole opposite to the first magnetic pole according to the enable signal; and a second monitor. The first mobile device is coupled to the second mobile device via attraction of the first and second magnetic poles.

### CROSS REFERENCE TO RELATED APPLICATIONS

This application claims priority of Taiwan Patent Application No. 100108678 filed on Mar. 15, 2011, the entirety of which is incorporated by reference herein.

### BACKGROUND OF THE INVENTION

1. Field of the Invention

The disclosure generally relates to a compound electronic device, and more particularly, relates to a compound electronic device which combines a plurality of mobile devices together.

2. Description of the Related Art

Personal mobile electronic devices, e.g., mobile phones, tablet PCs, PDA (personal digital assistant), and notebooks, have become a necessity in modern daily life. Personal mobile electronic devices are expected to be compact in size for convenience. However, some personal mobile electronic devices with monitors can not provide large and clear images due to the small size limitations. For instance, a mobile phone can be utilized for playing movies, but a user would prefer viewing movies on a TV or PC, due to the small screen of the mobile phone.

To solve above problem, a compound electronic device which quickly combines a plurality of mobile devices together is desired.

### BRIEF SUMMARY OF THE INVENTION

In one exemplary embodiment, the disclosure is directed to a compound electronic device, comprising: a first mobile device, comprising: a first electromagnet, generating a first magnetic pole; and a first monitor; a second mobile device, comprising: a sensor, detecting the first magnetic pole, and generating an enable signal according to the first magnetic pole; a second electromagnetic, generating a second magnetic pole opposite to the first magnetic pole according to the enable signal; and a second monitor, wherein the first mobile device is coupled to the second mobile device via attraction of the first and second magnetic poles.

In another exemplary embodiment, the disclosure is directed to an image displaying method, comprising the steps of: generating a first magnetic pole via a first mobile device; detecting the first magnetic pole and generating an enable signal according to the first magnetic pole via a second mobile device; and generating a second magnetic pole opposite to the first magnetic pole according to the enable signal via the second mobile device, wherein the first mobile device is coupled to the second mobile device via attraction of the first and second magnetic poles in order to display image data together.

### BRIEF DESCRIPTION OF DRAWINGS

The invention can be more fully understood by reading the subsequent detailed description and examples with references made to the accompanying drawings, wherein:

FIG. 1 is a diagram illustrating a compound electronic device according to an embodiment of the invention;

FIG. 2 is a diagram illustrating displaying an image data together according to an embodiment of the invention;

FIG. 3 is a diagram illustrating a compound electronic device according to an embodiment of the invention;

FIG. 4 is a diagram illustrating a compound electronic device according to an embodiment of the invention;

FIG. 5 is a diagram illustrating a compound electronic device according to an embodiment of the invention;

FIG. 6 is a diagram illustrating a compound electronic device according to an embodiment of the invention;

FIG. 7 is a diagram illustrating a compound electronic device according to an embodiment of the invention;

FIG. 8A is a diagram illustrating a compound electronic device according to an embodiment of the invention;

FIG. 8B is a diagram illustrating a compound electronic device according to an embodiment of the invention;

FIG. 9 is a flow chart illustrating an image displaying method according to an embodiment of the invention.

### DETAILED DESCRIPTION OF THE INVENTION

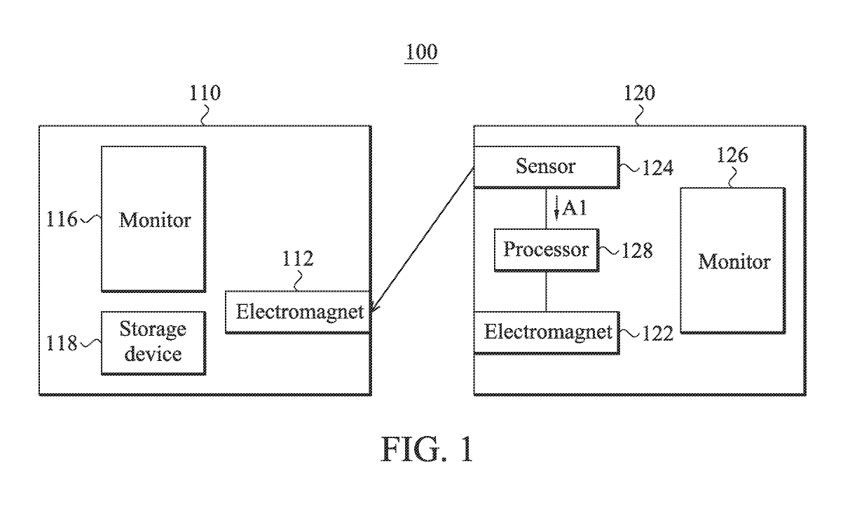

FIG. 1 is a diagram illustrating a compound electronic device 100 according to an embodiment of the invention. As shown in FIG. 1, the compound electronic device 100 comprises mobile devices 110, 120 that may be mobile phones, tablet PCs, PDAs, notebooks, or other portable electronic devices with monitors. The mobile device 110 may comprise: an electromagnet 112, a monitor 116, and a storage device 118. The mobile device 120 may comprise: an electromagnet 122, a sensor 124, a monitor 126, and a processor 128. The processor 128 is coupled to the sensor 124 and the electromagnet 122. The electromagnets 112, 122 may consist of coils and an iron core, or only coils. The sensor 124 may be a hall sensor to detect nearby magnetic poles or magnetic fields. The monitors 116, 126 may be LCD (liquid crystal display) monitors. The storage device 118 may be a memory, a hard disc, or DVD.

To begin, the electromagnet 112 of the mobile device 110 generates a first magnetic pole, N pole or S pole. It is noted that an electromagnetic must generate two magnetic poles at two ends concurrently, and the first magnetic pole means a magnetic pole of the electromagnet 112 that generates a magnetic field toward the outside of the mobile device 110. When a distance between the mobile devices 110, 120 is shorter than a predetermined distance, the sensor 124 can detect near by magnetic fields, determine whether the first magnetic pole is an N pole or S pole, and generate an enable signal A1 according to the detection. The processor 128 of the mobile device 120 can determine a current direction of the electromagnet 122 to generate a second magnetic pole opposite to the first magnetic pole according to the enable signal A1. For example, if the first magnetic pole is an N pole, the second magnetic pole is an S pole; and if the first magnetic pole is an S pole, the second magnetic pole is an N pole. Finally, the electromagnets 112, 122 attract each other due to being opposite magnetic poles, and the mobile device 110 is coupled to the mobile device 120 via attraction of the electromagnets 112, 122. When the mobile device 110 is coupled to the mobile device 120, each of the mobile devices 110, 120 generates a vibration alert to inform a user. Although only the sensor 124 of the mobile device 120 detects nearby magnetic fields as shown in FIG. 1, the mobile device 110 can also comprise another sensor and processor and be coupled to the mobile device 120 in the same way. The mobile devices 110, 120 can share data, e.g., video or music files, wirelessly via Bluetooth or Wi-Fi connection.

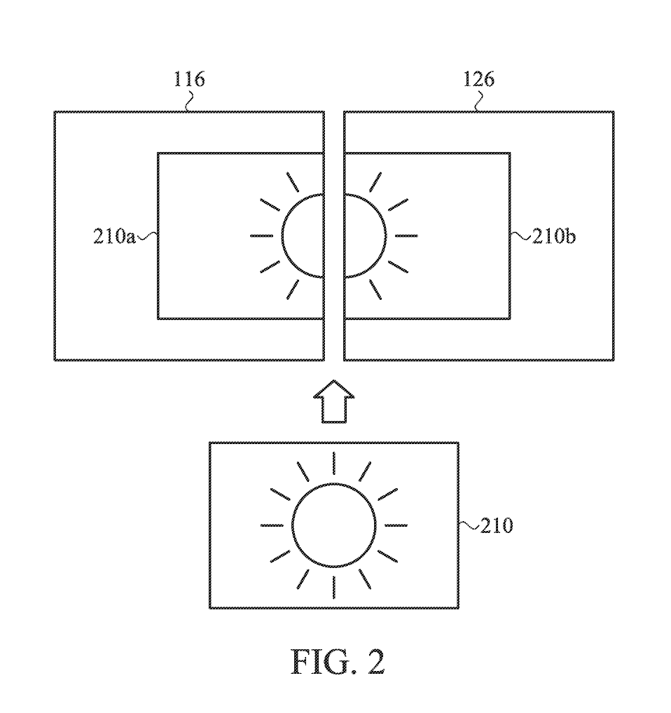

FIG. 2 is a diagram illustrating displaying an image data together according to an embodiment of the invention. The storage device 118 is configured to store image data 210. Each of mobile devices 110, 120 may comprise an application program. The mobile devices 110, 120 may share the image data 210 wirelessly via the application programs concurrently. The image data 210 may be a movie, a TV program, or a picture. As shown in FIG. 2, the image data can be divided up into sub-images 210a, 210b. When the mobile device 110 is coupled to the mobile device 120, each of the monitors 116, 126 may display part of the image data 210, e.g., the monitors 116, 126 display sub-images 210a, 210b, respectively, to constitute a complete image data 210. Although there are only two mobile devices as shown in FIG. 2, the compound electronic device 100 may comprise 4, 9, or more mobile devices that display one image data together via attraction of the electromagnets.

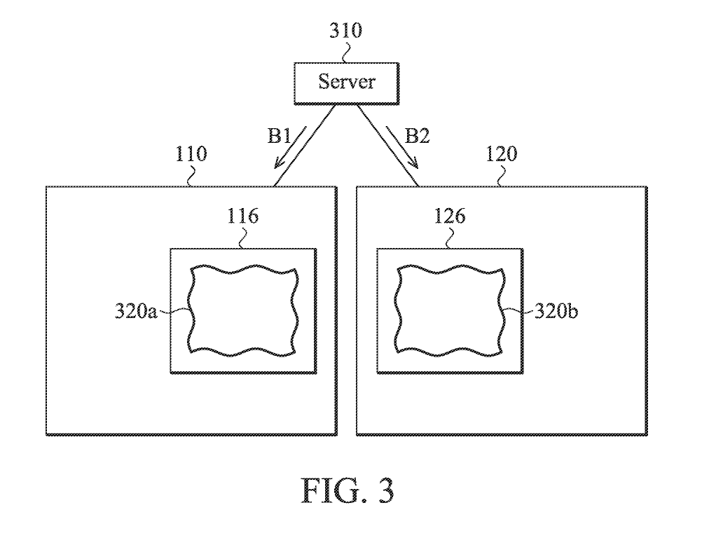

FIG. 3 is a diagram illustrating a compound electronic device according to an embodiment of the invention. As shown in FIG. 3, a server 310 of an online game is coupled to the mobile devices 110, 120 in a wired or wireless way, and transmits commands B1, B2 to the mobile devices 110, 120, respectively. After connection, the monitor 116 of the mobile device 110 and the monitor 126 of the mobile device 120 may display frames 320a, 320b of the online game according to the commands B1, B2, respectively. For example, the frame 320a is a background, and the frame 320b is a map thumbnail of the online game. In another embodiment, the frames 320a, 320b may be combined to constitute another background of the online game. Through connection of the mobile devices 110, 112, a player can have a larger screen to play the online game.

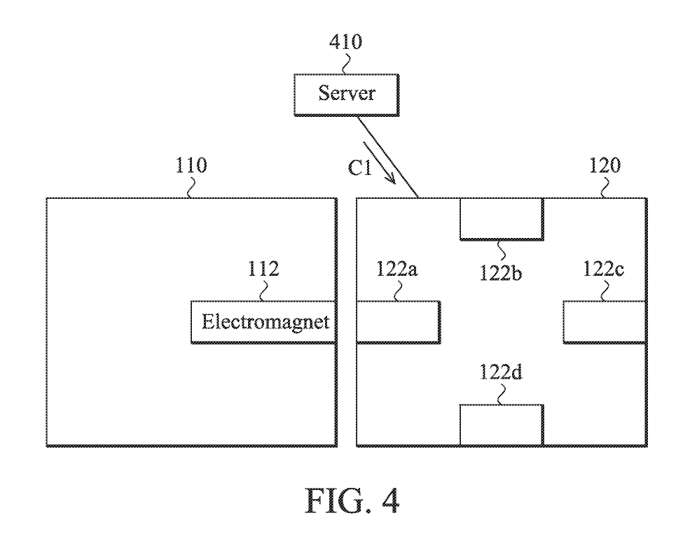

FIG. 4 is a diagram illustrating a compound electronic device according to an embodiment of the invention. As shown in FIG. 4, a server 410 is coupled to the mobile device 120 in a wired or wireless way, and transmits a control command C1. The electromagnet 122 of the mobile device 120 may comprise a plurality of the sub-electromagnets 122a, 122b, 122c, 122d that are disposed on four sides of the mobile device 120, respectively. Although there are only 4 sub-electromagnets disposed on the 4 sides as shown in FIG. 4, there may be different number of the sub-electromagnets, e.g., 2 sub-electromagnets disposed on 2 sides of the mobile device 120, respectively. During the connection, the mobile device 120 may receive the control command C1 and select one of the plurality of sub-electromagnets according to the control command C1 in order to attract the electromagnet 112 of the mobile device 110. For example, if the control command C1 indicates the sub-electromagnet 122a, the processor (not shown) of the mobile device 120 will command the sub-electromagnet 122a to generate a second magnetic pole with a polarity that is opposite to a polarity of a first magnetic pole of the electromagnet 112. The other sub-electromagnets 122b, 122c, 122d can have no power and can be non-magnetic. Therefore, the mobile device 120 can be coupled to the electromagnet 112 of the mobile device 110 through the sub-electromagnet 122a selected by the server 410.

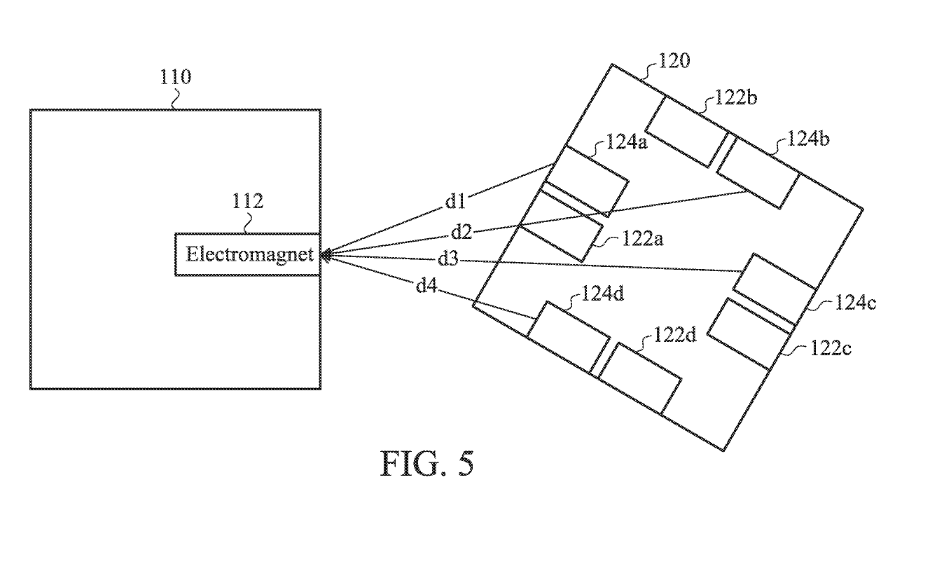

FIG. 5 is a diagram illustrating a compound electronic device according to an embodiment of the invention. As shown in FIG. 5, the electromagnet 122 of the mobile device 120 may comprise a plurality of the sub-electromagnets 122a, 122b, 122c, 122d that are disposed on four sides of the mobile device 120, respectively. Although there are only 4 sub-electromagnets disposed on the 4 sides as shown in FIG. 5, there may be different number of the sub-electromagnets, e.g., 2 sub-electromagnets disposed on 2 sides of the mobile device 120, respectively. The sensor 124 of the mobile device 120 may comprise a plurality of sub-sensors 124a, 124b, 124c, 124d that are disposed on four sides of the mobile device 120, respectively. Although there are only 4 sub-sensors disposed on the 4 sides as shown in FIG. 5, there may be different number of sub-sensors, e.g., 2 sub-sensors disposed on 2 sides of the mobile device 120, respectively. The sub-sensors 124a, 124b, 124c, 124d detect distances d1, d2, d3, d4 between the electromagnet 112 and the sub-electromagnets 122a, 122b, 122c, 122d, respectively. The processor (not shown) of the mobile device 120 may determine which one is the shortest among distances d1, d2, d3, d4 and select one of the sub-electromagnets 122a, 122b, 122c, 122d that has the shortest distance of all detected distances d1, d2, d3, d4. For example, if the processor determines that the distance d1 is the shortest, it will command the sub-electromagnet 122a to generate a second magnetic pole with a polarity that is opposite to a polarity of a first magnetic pole of the electromagnet 112. The other sub-electromagnets 122b, 122c, 122d can have no power and can be non-magnetic. Therefore, the mobile device 120 can be coupled to the electromagnet 112 of the mobile device 110 through the nearest sub-electromagnet 122a.

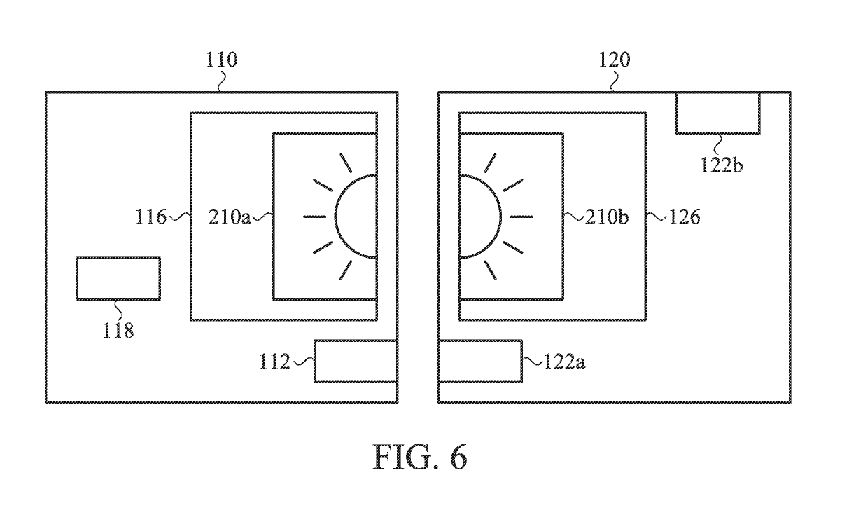

FIG. 6 is a diagram illustrating a compound electronic device according to an embodiment of the invention. As shown in FIG. 6, the electromagnet 122 of the mobile device 120 may comprise a plurality of the sub-electromagnets 122a, 122b that are disposed on two sides of the mobile device 120, respectively. Although there are only 2 sub-electromagnets disposed on the 2 sides as shown in FIG. 6, there may be different number of the sub-electromagnets, e.g., 4 sub-electromagnets disposed on 4 sides of the mobile device 120, respectively. The storage device 118 of the mobile device 110 is configured to store image data 210. Each of the mobile devices comprises an application program. Through wireless connection and the application program, the mobile devices 110, 120 may share the image data 210. The image data 210 may be a movie, a TV program, or a picture. The image data 210 may be divided up into sub-images 210a, 210b. To begin, the mobile device 110 is coupled to the mobile device 120, and both display the image data 210 together. Next, the mobile devices 110, 120 are separated from each other, and each of the monitors 116, 126 displays a part of the image data 210, e.g., the monitor 116 displays the sub-image 210a, and the monitor 126 displays the sub-image 210b. If a user wants to combine the mobile devices 110, 120 that are displaying different sub-images, a processor (not shown) of the mobile device 120 will select one of the sub-electromagnets 122a, 122b to be coupled to the electromagnet 112 of the mobile device 110 in order to combine the sub-images 210a, 210b into the complete data image 210. For example, the processor of the mobile device 120 must command the sub-electromagnet 122a to generate a second magnetic pole with a polarity that is opposite to a polarity of a first magnetic pole of the electromagnet 112. The other sub-electromagnet 122b can have no power and can be non-magnetic. Therefore, a wrong combination of mobile devices and a wrong display can be avoided.

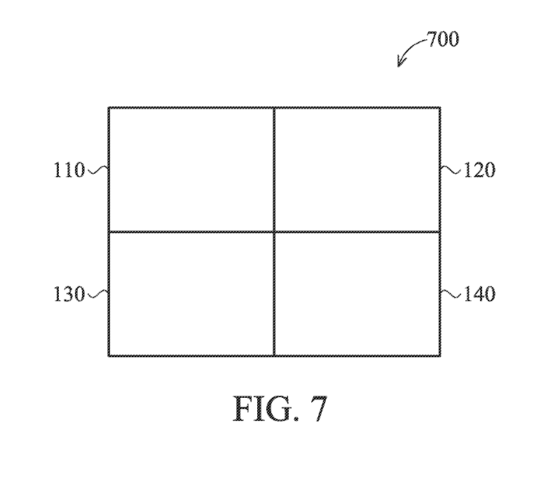

FIG. 7 is a diagram illustrating a compound electronic device according to an embodiment of the invention. As shown in FIG. 7, the mobile devices 110, 120, 130, 140 are combined into a compound electronic device 700 via attraction of the sub-electromagnets disposed on four sides of each of the mobile devices 110, 120, 130, 140. Although there are only 4 mobile devices combined as shown in FIG. 7, there may be 6, 8, 9, or more mobile devices combined into one compound electronic device shaped like a rectangular.

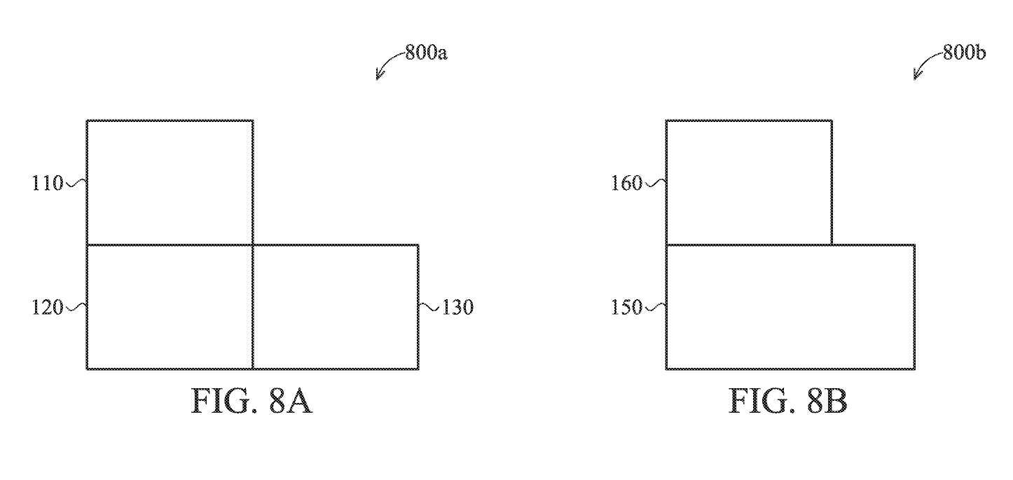

FIG. 8A is a diagram illustrating a compound electronic device according to an embodiment of the invention. As shown in FIG. 8A, the mobile devices 110, 120, 130 are combined into a compound electronic device 800a via attraction of the sub-electromagnets disposed on four sides of each of the mobile devices 110, 120, 130. Although there are only 3 mobile devices combined as shown in FIG. 8, there may be 3, 5, 7, or more mobile devices combined into one compound electronic device shaped like a non-rectangle.

FIG. 8B is a diagram illustrating a compound electronic device according to an embodiment of the invention. As shown in FIG. 8B, the mobile devices 150, 160 having different sizes can be combined into a compound electronic device 800b via attraction of the sub-electromagnets disposed on four sides of each of the mobile devices 150, 160.

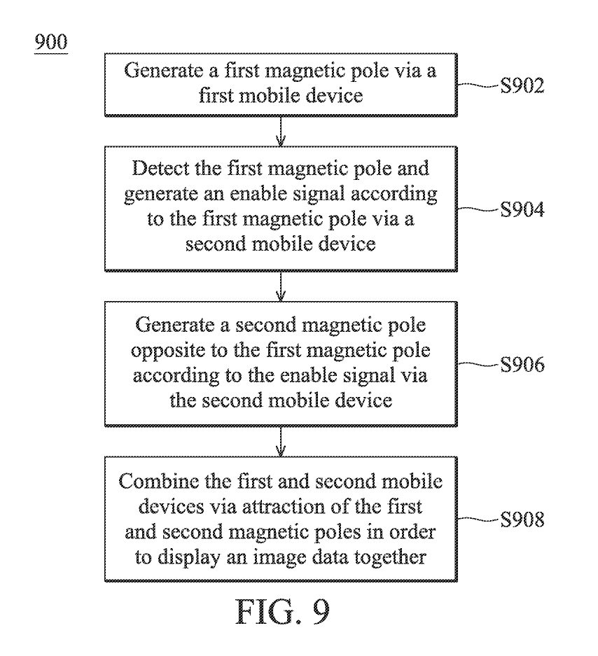

FIG. 9 is a flow chart 900 illustrating an image displaying method according to an embodiment of the invention. To begin, in step S902, a first magnetic pole via a first mobile device is generated. In step S904, the first magnetic pole is detected and an enable signal is generated according to the first magnetic pole via a second mobile device. In step S906, a second magnetic pole opposite to the first magnetic pole is generated according to the enable signal via the second mobile device. Finally, in step S908, the first and second mobile devices are combined via attraction of the first and second magnetic poles in order to display image data together, to end the flow chart. The way to display the image data is shown in FIGS. 2, 3, and 6.

In prior art, permanent magnets are usually utilized which combines a plurality of apparatuses. According to the invention, polarity of an electromagnet can be adjusted in order to combine a plurality of mobile devices easily. Moreover, the sensor can reduce power consumption of the plurality of electromagnets.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A compound electronic device, comprising:
a first mobile device, comprising:
a first electromagnet, arranged for generating a first magnetic pole; and
a first monitor; and
a second mobile device, comprising:
a sensor, arranged for detecting the first magnetic pole, and generating an enable signal according to the first magnetic pole;
a second electromagnetic, arranged for generating a second magnetic pole opposite to the first magnetic pole according to the enable signal; and
a second monitor,
wherein the first mobile device is coupled to the second mobile device via attraction of the first and second magnetic poles.

2. The compound electronic device as claimed in claim 1, wherein when the first mobile device is coupled to the second mobile device, each of the first and second mobile devices generates a vibration alert.

3. The compound electronic device as claimed in claim 1, wherein when the first mobile device is coupled to the second mobile device, the first monitor is arranged for displaying a first sub-image of an image data, the second monitor is arranged for displaying a second sub-image of the image data, and the first and second sub-images constitute the complete image data.

4. The compound electronic device as claimed in claim 3, wherein each of the first and second mobile devices comprises an application program, and shares the image data via the application program.

5. The compound electronic device as claimed in claim 1, wherein:
the first mobile device receives a first command from a server, and the second mobile device receives a second command from the server;
the first monitor is arranged for displaying a first frame of an online game according to the first command; and
the second monitor is arranged for displaying a second frame of the online game according to the second command.

6. The compound electronic device as claimed in claim 5, wherein the first frame is a background of the online game, and the second frame is a map thumbnail of the online game.

7. The compound electronic device as claimed in claim 1, wherein:
the second electromagnet comprises a plurality of sub-electromagnets, and each of which is disposed on each of sides of the second mobile device; and
the second mobile device is arranged for determining a polarity of one of the plurality of sub-electromagnets according to a control command from a server in order to attract the first electromagnet.

8. The compound electronic device as claimed in claim 1, wherein:
the second electromagnet comprises a plurality of sub-electromagnets, and each of which is disposed on each of sides of the second mobile device;
the sensor comprises a plurality of sub-sensors, each of which is disposed on each of the sides of the second mobile device and configured to detect a distance between each of the plurality of sub-electromagnets and the first electromagnet; and
the second mobile device is arranged for determining the polarity of one of the plurality of sub-electromagnets that has the shortest detected distance in order to attract the first electromagnet.

9. The compound electronic device as claimed in claim 1, wherein:
the second electromagnet comprises a plurality of sub-electromagnets, and each of which is disposed on each of sides of the second mobile device;
the first monitor is arranged for displaying a first sub-image of an image data;
the second monitor is arranged for displaying a second sub-image of the image data; and
the second mobile device is arranged for determining a polarity of one of the plurality of sub-electromagnets according to the first and second sub-images in order to attract the first electromagnet and combine the first and second sub-images into the complete image data.

10. An image displaying method, comprising the steps of:
generating a first magnetic pole via a first mobile device;
detecting the first magnetic pole and generating an enable signal according to the first magnetic pole via a second mobile device;
generating a second magnetic pole opposite to the first magnetic pole according to the enable signal via the second mobile device; and
combining the first and second mobile devices via attraction of the first and second magnetic poles in order to display image data together.

11. The image displaying method as claimed in claim 10, wherein when the first and second mobile devices are combined together, each of the first and second mobile devices generates a vibration alert.

12. The image displaying method as claimed in claim 10, wherein when the first and second mobile devices are combined together, the method further comprises:
displaying a first sub-image of an image data via the first mobile device; and
displaying a second sub-image of the image data via the second mobile device,
wherein the first and second sub-images constitute the complete image data.

13. The image displaying method as claimed in claim 10, further comprising the steps of:
receiving a first command and a second command via the first and second mobile devices, respectively, from a server;
displaying a first frame of an online game according to the first command via the first mobile device; and
displaying a second frame of the online game according to the second command via the second mobile device.

14. The image displaying method as claimed in claim 13, wherein the first frame is a background of the online game, and the second frame is a map thumbnail of the online game.

15. The image displaying method as claimed in claim 10, wherein the second mobile device comprises a plurality of the sub-electromagnets, each of which is disposed on each side of the second mobile device, and the image displaying method further comprises the steps of:
detecting, via the second mobile device, a distance between each of the plurality of the sub-electromagnets and the first electromagnet; and
determining, via the second mobile device, the polarity of one of the plurality of the sub-electromagnets that has the shortest detected distance in order for connection to the first mobile device.

16. The image displaying method as claimed in claim 10, wherein the second mobile device comprises a plurality of the sub-electromagnets, each of which is disposed on each side of the second mobile device, and the image displaying method further comprises the steps of:
displaying a first sub-image of the image data via the first mobile device; and
displaying a second sub-image of the image data via the second mobile device,
wherein the second mobile device determines the polarity of one of the plurality of the sub-electromagnets according to the first and second sub-images in order for connection to the first mobile device and combines the first and second sub-images into the complete image data.
